(19) United States
(12) Patent Application Publication
(10) Pub. No.: US 2022/0147802 A1
(43) Pub. Date: May 12, 2022

(54) PORTABLE DEVICE AND METHOD USING ACCELERATED NETWORK SEARCH ARCHITECTURE

(71) Applicant: National Applied Research Laboratories, Taipei City (TW)

(72) Inventors: YI-CHUAN LIANG, New Taipei City (TW); SHIH-HAO HUNG, Taipei City (TW); YI-LUN PAN, Hsinchu City (TW)

(21) Appl. No.: 17/367,529

(22) Filed: Jul. 5, 2021

(30) Foreign Application Priority Data
Nov. 6, 2020 (TW) 109138842

(51) Int. Cl. G06N 3/063; G06N 3/04

(52) U.S. Cl. CPC G06N 3/063; G06N 3/04

(57) ABSTRACT

A portable device and a method using an accelerated network search architecture are provided. When a portable media component is connected to a client device, the portable media component outputs an identification signal. After the identification signal is successfully identified by a server, the server collects an agent dataset described in a high-level language from the client device through an accelerated network search platform. The server looks up a dataset that has characteristics similar to the agent dataset from a computing resource through the accelerated network search platform to output a candidate model. A client program dynamically updates and outputs performance data to the server according to actual performance of the client device executing the candidate model. The server modifies the candidate model according to the performance data multiple times, so as to train an optimized model for the client device to use.

### CROSS-REFERENCE TO RELATED PATENT APPLICATION

This application claims the benefit of priority to Taiwan Patent Application No. 109138842, filed on Nov. 6, 2020. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to neural architecture search (NAS), and more particularly to a portable device and a method using an accelerated network search architecture.

### BACKGROUND OF THE DISCLOSURE

A neural network search architecture is searched according to a given search strategy in a preset search space. A machine is often used to train an optimal mode based on the searched neural network search architecture. The optimal model can be evaluated according to evaluation metrics. It is well known that complex computing operations need to be executed to train a model multiple times, so as to finally obtain the optimal model having best quality. However, many clients do not own computing devices that are capable of executing the complex computing operations, and yet the clients must protect their confidential information from being leaked to an external search platform. Therefore, the neural network search architecture matched with the client device cannot be precisely searched and computed according to the confidential information of the client. As a result, the trained model has poor quality and is not suitable for being used by the client device. Further, an actual performance of the client device executing the trained model cannot be accurately analyzed and modified in real time.

### SUMMARY OF THE DISCLOSURE

In response to the above-referenced technical inadequacies, the present disclosure provides a portable device using an accelerated network search architecture. The portable device includes a portable media component and a server. The portable media component is configured to output an identification signal when the portable media component is connected to a client device. The server is connected to the portable media component and configured to identify the identification signal. After the identification signal is successfully identified by the server, the server provides an accelerated network search platform. The server collects data characteristics that are described in a high-level language by a client from the client device through the accelerated network search platform. The server generates an agent dataset based on the data characteristics from the client device. The server looks up a dataset that has characteristics similar to the data characteristics described by the client from a computing resource in a data center through the accelerated network search platform according to the agent dataset. The server searches a large amount of neural network architectures from the computing resource through the accelerated network search platform. The server selects one of the neural network architectures according to the dataset that is looked up from the computing resource. The server outputs a candidate model according to the one of the neural network architectures. The client device generates performance data according to actual performance of a hardware of the client device executing the candidate model. A client program is installed on a target platform by the client device. The client device dynamically updates and outputs the performance data to the server via the client program. The server modifies the candidate model multiple times according to the performance data that is updated multiple times to finally train an optimized model. The server provides the optimized model to the client device, and the optimized model is executed on the client device.

In certain embodiments, the client program generates a performance metric according to the actual performance of the hardware of the client device executing the candidate model updated each time. The server provides a just-in-time performance model module configured to dynamically update a just-in-time performance model according to the performance metric that is updated each time. The candidate model is optimized according to the just-in-time performance model on the accelerated network search platform.

In certain embodiments, the just-in-time performance model module determines a difference between desired performance and the actual performance of the hardware of the client device executing the candidate model. The just-in-time performance model module outputs the difference to the server. The server searches another one of the neural network architectures from the computing resource through the accelerated network search platform according to the difference. The server trains the candidate model into the optimized model according to the another one of the neural network architectures.

In certain embodiments, the server is configured to obtain client requirement oriented information of the client from the client device. The server trains the optimized model according to the client requirement oriented information and provides the optimized model to the client device. The client requirement oriented information includes an accuracy, latency, throughput, memory access costs, a number of times of executing floating point operations per second, or any combination thereof.

In certain embodiments, the portable media component includes a USB flash drive, a tensor processing unit (TPU), a graphics processing unit (GPU), a field programmable gate array (FPGA) component, or any combination thereof.

In addition, the present disclosure provides a method using an accelerated network search architecture. The method includes the following steps: generating an identification signal by executing a portable media on a client device; identifying the identification signal by a server; collecting data characteristics described in a high-level language from the client device and generating an agent dataset based on the data characteristics, by the server; looking up a dataset that has characteristics similar to the data characteristics from a computing resource in a data center through an accelerated network search platform, according to the agent dataset, by the server; searching a large amount of neural network architectures from the computing resource through the accelerated network search platform, selecting one of the neural network architectures according to the dataset, and outputting a candidate model based on the one of neural network architectures, by the server; executing the candidate model by a hardware of the client device; executing a software agent on the client device to generate and continually update performance data according to actual performance of the hardware of the client device executing the candidate model, and providing the performance data to the server; and optimizing the candidate model according to the performance data multiple times to finally train an optimized model and providing the optimized model to the client device by the server, and executing the optimized model on the client device.

In certain embodiments, the method using the accelerated network search architecture includes the following steps: executing the software agent on the client device to generate a performance metric according to the actual performance of the hardware of the client device executing the candidate model each time; dynamically updating in real time a just-in-time performance model according to the performance metric that is updated each time by the server; and optimizing the candidate model according to the just-in-time performance model that is updated multiple times by the server, so as to finally train the optimized model for the client device to use.

In certain embodiments, the method using the accelerated network search architecture includes the following steps: determining, by the server, a difference between a desired performance and the actual performance of the hardware of the client device executing the candidate model; selecting, by the server, another one of the neural network architectures according to the difference through the accelerated network search platform; and training, by the server, the candidate model into the optimized model according to the another one of the neural network architectures.

In certain embodiments, the method using the accelerated network search architecture includes the following steps: providing client requirement oriented information by the client device, in which the client requirement oriented information includes an accuracy, latency, throughput, memory access costs, a number of times of executing floating point operations per second, or any combination thereof; and training the optimized model according to the client requirement oriented information and providing the optimized model to the client device, by the server.

In certain embodiments, the method using the accelerated network search architecture includes the following steps: determining, by the server, whether or not the performance data currently obtained is the same as the performance data previously obtained. In response to determining that the performance data currently obtained is the same as the performance data previously obtained, providing the candidate model that is the same as the performance data previously provided, and in response to determining that the performance data currently obtained is not the same as the performance data previously obtained, training the candidate model according to the performance data currently obtained.

As described above, the portable device and the method using the accelerated network search architecture have the following advantages:
1. The portable device is lightweight, and provides a training computing desktop environment to the client device that is easily and conveniently used by the client.
2. The complexity of the computing operations performed in the data center is reduced, and a portable application service is provided.
3. Only one portable media component is required to serve as a medium for triggering the client device to be powered on, the client device is connected to the server through the portable media component and connected to the remote data center through the server, and the client device obtains the neural network architecture that is most suitable for the hardware of the client device.
4. The hardware of the portable media component of the client device is automatically detected and obtained under the condition that confidential information of the client is protected from being leaked, and the model is generated according to the information of the hardware architecture of the client device based on the computing resource in the data center within the limited range of the client requirement oriented information.
5. If the client intends to obtain the optimized model, the client only needs to provide the dataset or the desired model architecture that is described in the high-level language without providing the confidential dataset of the client.
6. The platform-aware neural architecture search technology is applied to the server and the client device, the server efficiently and accurately executes the arithmetic operations to obtain the appropriate neural network architecture from the computing resource and train the optimized model according to the neural network architecture, and the optimized model can be easily executed on the client device.
7. According to the client requirement oriented information, the server initially generates the candidate model based on the high-level language descriptions of the client. The candidate model is executed on the client device, and then the client program dynamically provides the performance data of the just-in-time performance model of the client device to the server. The server automatically executes the accelerated network search algorithm on the performance data and optimizes the candidate model multiple times to finally train the optimized model.
8. Various types of the portable media component (such as the USB flash drive) and containerization technology can be used, and a hardware resource expropriation mode and a hardware resource non-expropriation are provided. If the client device selects the hardware resource non-expropriation, the client can use the service of the portable media component once. Conversely, if the client device selects the hardware resource expropriation mode, the operating system, the firmware and the databases that are matched with the client device can be installed on the client device via the portable media component. These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of a portable device using an accelerated network search architecture according to an embodiment of the present disclosure;

FIG. 2 is a schematic diagram showing a flash drive of the portable device using the accelerated network search architecture being inserted into a client device according to the embodiment of the present disclosure;

FIG. 3 is a schematic diagram of an algorithm architecture of the portable device using the accelerated network search architecture according to the embodiment of the present disclosure; and

FIG. 4 is a flowchart diagram of a method using the accelerated network search architecture according to the embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

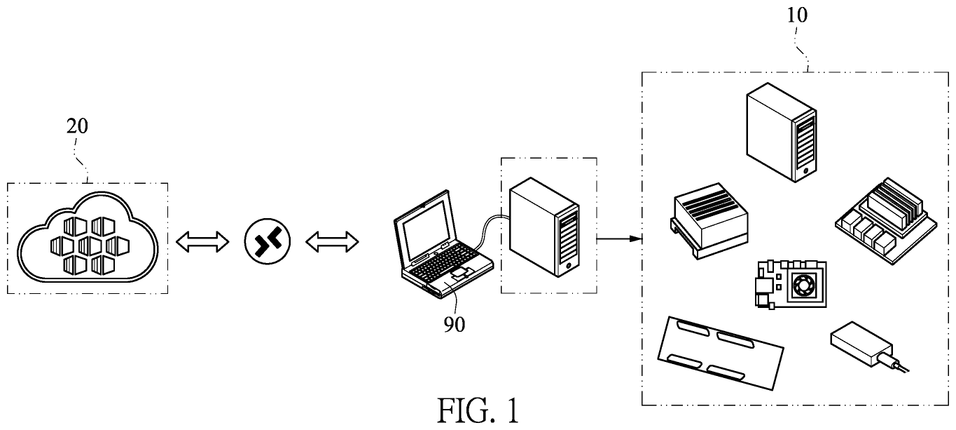

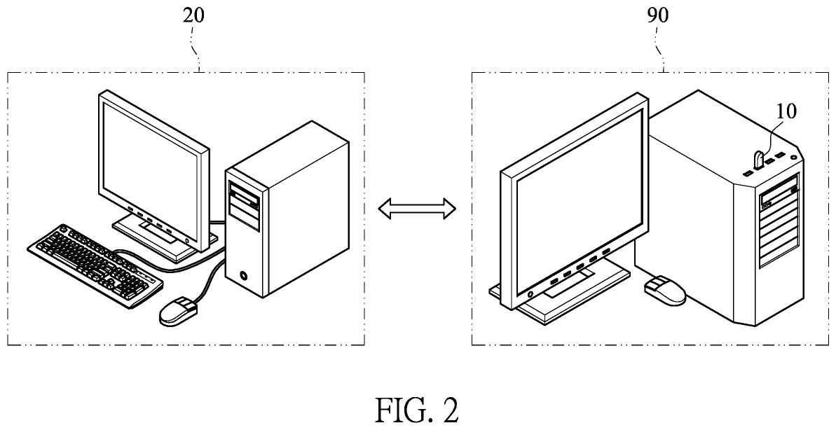

Reference is made to FIGS. 1 and 2, in which FIG. 1 is a schematic diagram of a portable device using an accelerated network search architecture according to an embodiment of the present disclosure, and FIG. 2 is a schematic diagram of the client device into which a flash drive of the portable device using the accelerated network search architecture is inverted according to the embodiment of the present disclosure.

As shown in FIG. 1, in the embodiment, the portable device using the accelerated network search architecture may include a portable media component 10 and a server 20. For example, the portable media component 10 may include a USB flash drive (that can be used to trigger a client device 90 to be powered on), a tensor processing unit (TPU), a graphics processing unit (GPU), and a field programmable gate array (FPGA) component, but the present disclosure is not limited thereto.

A client program 11 is installed on the client device 90 and used as an agent for the accelerated network search architecture. The portable media component 10 may be connected to the client device 90. For example, the portable media component 10 is the field programmable gate array (FPGA) component as shown in FIG.1, and is connected to the client device 90 through a USB connection wire. Alternatively, the portable media component 10 is the USB flash drive, and is inserted into a USB slot of the client device 90 as shown in FIG. 2. The portable media component 10 can automatically scan a hardware of the client device 90 and execute other appropriate programs to automatically set a neural network search environment on the client device 90. A specific description thereof is as follows.

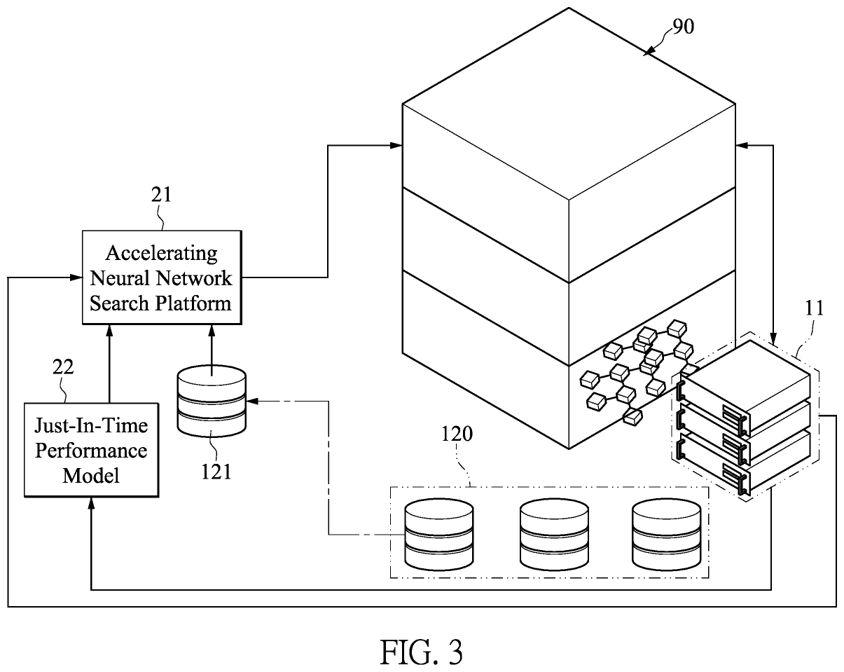

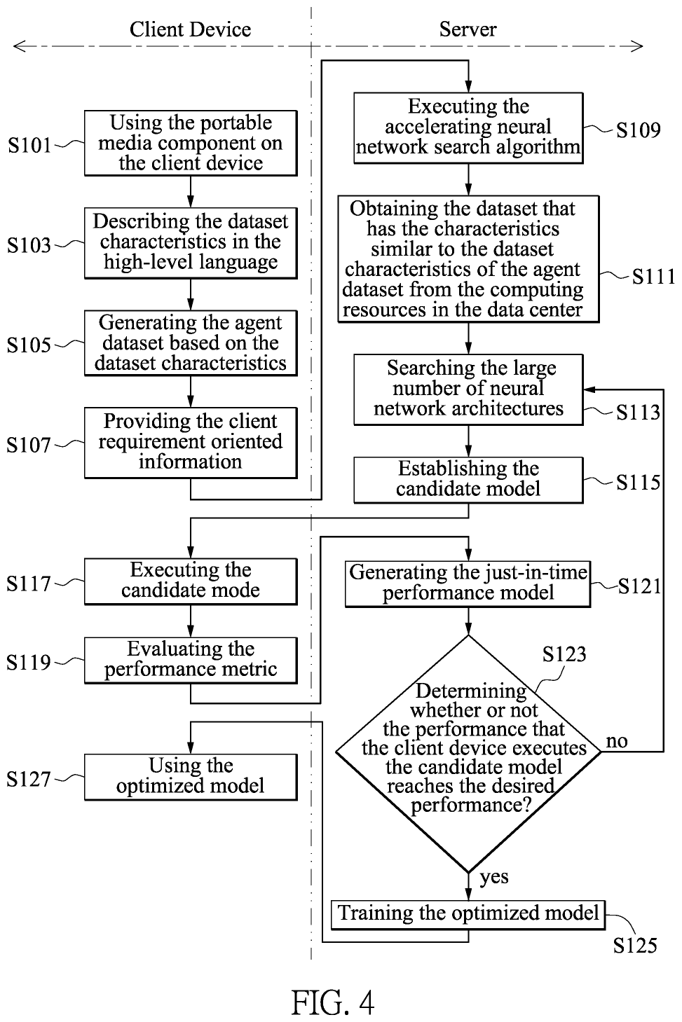

Reference is made to FIGS. 3 and 4, in which FIG. 3 is a schematic diagram of an algorithm architecture of the portable device using the accelerated network search architecture according to the embodiment of the present disclosure, and FIG. 4 is a flowchart diagram of a method using the accelerated network search architecture according to the embodiment of the present disclosure.

In the embodiment, the method using the accelerated network search architecture may include steps S101 to S127 shown in FIG. 4, which may be performed by the portable device of the accelerated network search architecture as shown in FIG. 3. The portable device may include an accelerated network search platform 21 provided by the server 20 and the portable media component 10 provided for the client device 90. The portable media component 10 is shown in FIG. 1 or FIG. 2, but the present disclosure is not limited thereto.

It should be understood that, according to actual requirements, one or more of the steps S101 to S127 described in the embodiment may be appropriately reduced or omitted, an order and a number of times of performing the steps S101 may be changed, and contents of the steps S101 to S127 may be adjusted. However, the present disclosure is not limited thereto.

First, the steps S101 to S107 are performed to collect requirements of a client.

In step S101, the portable media component 10 outputs an identification signal on the client device 90. When the portable media component 10 is connected to the client device 90 as shown in FIGS. 1 and 2, the portable media component 10 generates the identification signal and outputs the identification signal to the server 20 (through the client device 90).

In step S103, data characteristics (of a database or a desired model architecture) are described in a high-level language on the client device 90 by the client.

In step S105, the client device 90 generates an agent dataset 121 based on the data characteristics described in the high-level language. Alternatively, the server 20 generates the agent dataset 121 based on all information collected from (a database 120 of) the client device 90. The information may include the desired model architecture described in the high-level language and client requirement oriented information.

In step S107, the client device 90 provides the client requirement oriented information according to personal requirements of the client. For example, the client requirement oriented information may include an accuracy requirement of a model, such as a high correlation between a candidate model and an optimized model that are provided by the server 20 and the agent database, a good matching of the candidate model, the optimized model and the client device 90. Alternatively, the client requirement oriented information may include latency, throughput, memory access costs, a number of times of executing floating point operations per second, and so on. The server 20 may obtain the client requirement oriented information through a client requirement orienting module.

It should be note that, different clients may provide different client requirement oriented information. If the client cannot wait for a long time, the server 20 may provide a model having a low accuracy to the client device 90. However, if a high accuracy of the model is required for the client, the client needs to wait for a longer time.

Then, steps S109 to S115 are performed. In steps S109 to S115, neural network architectures are searched and the candidate model is initially established on the server 20.

In step S109, the server 20 executes an accelerated network search algorithm on the accelerated network search platform 21.

In step S111, within a limited range of the client requirement oriented information (such as a limited latency range or a limited time range), the server 20 looks up a dataset that has characteristics similar to the data characteristics (that may be described in the high-level language on the client device by the client) from a computing resource in a data center connected to the server 20, according to the agent dataset 121 of the client.

In step S113, the server 20 searches a large amount of neural network architectures from the computing resource and selects one of the neural network architectures according to the dataset looked up from the computing resource.

In step S115, the server 20 outputs the candidate model to the client device 90 according to the one of the neural network architectures that is matched with data of the agent dataset 121 of the client device 90. The one of the neural network architectures may be the desired model architecture described in the high-level language.

Then, steps S117 and S119 are performed to test actual performance of the candidate model established by the server 20 on the client device 90.

In step S117, the candidate model is executed by the hardware of the client device 90.

In step S119, the actual performance of the hardware of the client device 90 executing the candidate model is detected, so as to evaluate performance data (such as a performance metric) via a client program.

Finally, steps S121 to S127 are performed to train the optimized model.

In step S121, the server 20 detects the performance data of the client device 90 to generate a just-in-time performance model 22 via the just-in-time performance model module.

In step S123, the just-in-time performance model module of the server 20 determines whether or not the actual performance of the client device 90 executes the candidate model reaches performance that is desired by the client or predicted by the server 20, according to the just-in-time performance model 22. If the actual performance reaches the performance that is desired by the client or predicted by the server 20, step S125 is then performed.

Conversely, if the actual performance does not reach the performance that is desired by the client or predicted by the server 20, the just-in-time performance model module of the server 20 determines a difference between desired performance and the actual performance of the hardware of the client device executing the candidate model. Then, step S113 is performed again. In step S113, the server 20 searches a large amount of neural network architectures and selects another one of the neural network architectures according to the difference. Then, step S115 is performed again. In step S115, the server 20 modifies the candidate model to optimize the candidate model according to the another one of the neural network architectures. Then, step S117 is performed again. In step S117, the server 20 provides the candidate model to the client device 90 and the candidate model is executed on the client device 90 until the actual performance reaches the performance that is desired by the client or predicted by the server 20.

In step S125, the server 20 modifies the candidate model according to the performance data that is updated multiple times for convergence. Finally, the server 20 trains the optimized model according to a deep neural network architecture that is most suitable for the dataset, a software, the hardware and platforms of the client device 90, and the actual performance reaches the performance metric.

In step S127, the optimized model is executed by the hardware of the client device 90.

The portable device and the method using the accelerated network search architecture, which have following advantages:
1. the portable device has a lightweight and provides a training computing desktop environment to the client device that is easily and convenient to use for the client;
2. the complexity of the computing operations performed in the data center is reduced and a portable application service is provided;
3. only one portable media component is required as a medium used to trigger the client device to be powered on, the client device is connected to the server through the portable media component and connected to the remote data center through the server, and the client device obtains the neural network architecture that is most suitable for the hardware of the client device;
4. the hardware of the portable media component of the client device is automatically detected and obtained under the condition that confidential information of the client is protected from being leaking, and the model is generated according to the information of the hardware architecture of the client device based on the computing resource in the data center within the limited range of the client requirement oriented information;
5. if the client intends to obtain the optimized model, the client only needs to provide the dataset or the desired model architecture that is descried in the high-level language without providing the confidential dataset of the client;
6. the platform-aware neural architecture search technology is applied to the server and the client device, the server efficiently and accurately executes the arithmetic operations to obtain the appropriate neural network architecture from the computing resource and train the optimized model according to the neural network architecture, and the optimized model can be easily executed on the client device;
7. the server initially generates the candidate model based on the high-level language descriptions of the client according to the client requirement oriented information, the candidate model is executed on the client device and then the client program dynamically provides the performance data of the just-in-time performance model of the client device to the server, and the server automatically executes the accelerated network search algorithm on the performance data and optimizes the candidate model multiple times to finally train the optimized model;
8. Various types of portable media components such as the USB flash drive and containerization technology can be used, a hardware resource expropriation mode and a hardware resource non-expropriation are provided, if the client device selects the hardware resource non-expropriation, the client can use the service of the portable media component once, but the client device selects the hardware resource expropriation, the operating system, the firmware and the databases that are matched with the client device can be installed on the client device via the portable media component. The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A portable device using an accelerated network search architecture, comprising:
a portable media component configured to output an identification signal when the portable media component is connected to a client device; and
a server connected to the portable media component and configured to identify the identification signal, wherein, after the identification signal is successfully identified by the server, the server provides an accelerated neural network search platform, the server collects data characteristics that are described in a high-level language by a client from the client device through the accelerated network search platform, the server generates an agent dataset based on the data characteristics from the client device, the server looks up a dataset that has characteristics similar to the data characteristics described by the client from a computing resource in a data center through the accelerated network search platform according to the agent dataset, the server searches a large amount of neural network architectures from the computing resource through the accelerated network search platform, the server selects one of the neural network architectures according to the dataset that is looked up from the computing resource, and the server outputs a candidate model according to the one of the neural network architectures;
wherein the client device generates performance data according to actual performance of a hardware of the client device executing the candidate model, a client program is installed on a target platform by the client device, the client device dynamically updates and forwards the performance data to the server via the client program, the server modifies the candidate model multiple times according to the performance data that is updated multiple times to finally train an optimized model, the server provides the optimized model to the client device, and the optimized model is executed on the client device.

2. The portable device using the accelerated network search architecture according to claim 1, wherein the client program generates a performance metric according to the actual performance of the hardware of the client device executing the candidate model each time, the server provides a just-in-time performance model module configured to dynamically update a just-in-time performance model according to the performance metric that is updated each time, and the candidate model is optimized according to the just-in-time performance model on the accelerated network search platform.

3. The portable device using the accelerated network search architecture according to claim 2, wherein the just-in-time performance model module determines a difference between desired performance and the actual performance of the hardware of the client device executing the candidate model, the just-in-time performance model module forwards the difference to the server, the server searches another one of the neural network architectures from the computing resource through the accelerated network search platform according to the difference, and the server trains the candidate model into the optimized model according to the another one of the neural network architectures.

4. The portable device using the accelerated network search architecture according to claim 1, wherein the server is configured to obtain client requirement oriented information of the client from the client device, the server trains the optimized model according to the client requirement oriented information and provides the optimized model to the client device, and the client requirement oriented information includes an accuracy, latency, throughput, memory access costs, a number of times of executing floating point operations per second, or any combination thereof.

5. The portable device using the accelerated network search architecture according to claim 1, wherein the portable media component includes a USB flash drive, a tensor processing unit (TPU), a graphics processing unit (GPU), a field programmable gate array (FPGA) component, or any combination thereof.

6. A method using an accelerated network search architecture, comprising the following steps:
generating an identification signal by executing a portable media on a client device;
identifying the identification signal by a server;
collecting data characteristics described in a high-level language from the client device and generating an agent dataset based on the data characteristics, by the server;
looking up a dataset that has characteristics similar to the data characteristics from a computing resource in a data center through an accelerated neural network search platform according to the agent dataset, by the server;
searching a large amount of neural network architectures from the computing resource through the accelerated network search platform, selecting one of the neural network architectures according to the dataset, and outputting a candidate model based on the one of neural network architectures, by the server;
executing the candidate model by a hardware of the client device;
executing a software agent on the client device to generate performance data according to actual performance of the hardware of the client device executing the candidate model, and forwarding the performance data to the server; and
optimizing the candidate model according to the performance data that is updated multiple times to finally train an optimized model, providing the optimized model to the client device by the server, and executing the optimized model on the client device.

7. The method using the accelerated network search architecture according to claim 6, further comprising the following steps:
executing the software agent on the client device to generate a performance metric according to the actual performance of the hardware of the client device executing the dynamically-updated candidate model each time;
dynamically updating in real time a just-in-time performance model according to the performance metric that is updated each time by the server; and
optimizing the candidate model according to the just-in-time performance model that is updated multiple times by the server, so as to finally train the optimized model for the client device to use.

8. The method using the accelerated network search architecture of claim 6, further comprising the following steps:
determining, by the server, a difference between a desired performance and the actual performance of the hardware of the client device executing the candidate model;
selecting, by the server, another one of the neural network architectures according to the difference through the accelerated network search platform; and
training, by the server, the candidate model into the optimized model according to the another one of the neural network architectures.

9. The method using the accelerated network search architecture of claim 6, further comprising the following steps:
providing client requirement oriented information by the client device, wherein the client requirement oriented information includes an accuracy, latency, throughput, memory access costs, a number of times of executing floating point operations per second, or any combination thereof; and
training the optimized model according to the client requirement oriented information and providing the optimized model to the client device, by the server.

10. The method using the accelerated network search architecture of claim 6, further comprising the following step:
determining, by the server, whether or not the performance data currently obtained is the same as the performance data previously obtained, wherein, in response to determining that the performance data currently obtained is the same as the performance data previously obtained, the candidate model that is the same as the performance data previously obtained is provided, and in response to determining that the performance data currently obtained is not the same as the performance data previously obtained, the candidate model is trained according to the performance data currently obtained.
